(19) United States
(12) Patent Application Publication
(10) Pub. No.: US 2020/0170438 A1
(43) Pub. Date: Jun. 4, 2020

(54) PRESSURE FRYER

(71) Applicant: The Broaster Company, Beloit, WI (US)

(72) Inventors: Otley D. Freymiller, Deerfield, WI (US); Sean Spors, Rockton, IL (US); David N. Woods, Madison, WI (US); Raymond J. Robey, Madison, WI (US)

(21) Appl. No.: 16/702,171

(22) Filed: Dec. 3, 2019

Related U.S. Application Data
(60) Provisional application No. 62/774,616, filed on Dec. 3, 2018.

(51) Int. Cl. A47J 27/08

(52) U.S. Cl. CPC A47J 27/0817

(57) ABSTRACT

A pressure fryer includes a cooking vessel having a cooking well having a conical bottom and a substantially vertical sidewall extending upwardly from the conical bottom. A series of vertical fins are mounted to the sidewall and spaced from one another. A series of undulating fins are mounted between the vertical fins. The pressure fryer further includes filter system having a filter vessel having a body, an inlet, an outlet and a vent line. An outer basket is disposed in the body and an inner basket is disposed in the outer basket. Sidewalls of the outer and inner basket having openings therein. A filter media is disposed between the inner basket and the outer basket. A method for filtering used cooking oil in a pressure fryer is also disclosed.

### BACKGROUND

The present disclosure relates to a pressure fryer, and more particularly to a high efficiency cooking system and filtering system for a pressure fryer.

Pressure fryers use a sealed, pressurized environment in which foods are cooked. Such a cooking technique locks in the flavor of, and moisture in, the food and reduces the amount of oil that is absorbed by the food. The decrease in oil absorption extends the oil's useful life and thus reduces costs compared to deep frying. In addition, the reduced absorption of oil in the food reduces the transfer of flavors between cooked foods.

Known pressure fryers use a cooking vessel or cooking well that, again, is sealed and pressurized. One known pressure fryer, disclosed in Richard et al., U.S. Pat. No. 7,134,385, which patent is commonly assigned with the present application, has a circular, downwardly an inwardly tapered cooking well that operates between 12-14 psi gauge pressure at temperatures up to 375° F. The cooking well is formed from 300 series stainless steel.

Heat can be provided by gas fired burners or electric elements. Gas fired burners are conventional blue-flame burners. Heat transfer from the source, i.e., the flame, is essentially by convection only as the temperatures are not sufficiently high to produce heat transfer by other transfer means. A series of straight fins extend longitudinally, upwardly along the outer well wall to facilitate heat transfer to the well. It will be appreciated that while such an arrangement provides significant heat transfer to the well, and thus the cooking oil, a significant amount of energy is lost to the environment as a result of heating the pressurized cooking well by use of a blue flame.

It will also be appreciated the oil must be filtered at various times depending upon the frequency of use. During a down-time, usually a number of times during the work day, the oil is conveyed to a filter in the fryer, to filter out cooked food debris. In an known pressure fryer, the filter is a tray having openings that is located at the bottom of the fryer. A filter media is positioned in the tray and the oil is deposited in the tray. Once filtered, the oil is then pumped back into the cooking well. In a fairly typical day, filtering is carried out about every five cooking cycles and the media is changed out about every three filtering cycles. Again, in a typical commercial setting this is less than one day of cooking.

The time to filter the oil is about five minutes and the time to change out the filter media is about 15-20 minutes. Filter media change-out requires labor to clean out the filter pan and to dispose of the filter media. In addition, diatomaceous earth is used to achieve the desired level of filtration. As such, in addition to disposal of the used oil, the diatomaceous earth also requires disposal.

Accordingly, there is a need for a pressure fryer having an increased fuel usage efficiency. Desirably, such increased efficiency is made without increasing the physical size of the pressure fryer and without changing the fuel type used for the fryer. More desirably, such a pressure fryer has an improved filtering system that reduces the time and labor required for filtering the cooking oil.

### SUMMARY

In one aspect, an improved pressure fryer includes a cooking vessel having a cooking well with a conical bottom and a substantially vertical sidewall extending upwardly from the conical bottom. A cover covers the cooking well.

A series of vertical fins are mounted to the sidewall. The vertical fins are spaced from one another. In an embodiment, a series of undulating fins are mounted between the vertical fins. In an embodiment, the undulating fins define peaks and troughs. The series of undulating fins can include first and second fin elements. The cooking vessel can include a coating on a portion thereof. In an embodiment, the coating is disposed on a lower portion of the cooking vessel, below the fins. The coating can be, for example, a material to enhance heat transfer from a heat source to the cooking vessel.

The first and second fin elements are mounted to each other in an opposing overlying configuration, such that the peaks of the first fin elements overlie the toughs of the second fin element. The undulating fins can extend along a portion of the sidewall. The cooking vessel can include a heat shield positioned over the vertical and undulating fins.

The heat source for the cooking vessel can include a burner, such as an infrared (IR) burner.

In another aspect, a filter system for a pressure fryer includes a filter vessel having a body, an inlet, and an outlet. The filter system can include a vent line and a vent valve in the vent line. An outer basket is disposed in the body and has a sidewall having openings therein. The outer basket has a bottom wall. An inner basket is disposed in the outer basket. A sidewall of the inner basket has openings therein. The inner basket has a bottom wall.

A filter media can be disposed between the inner basket and the outer basket. In an embodiment, the filter media is reusable. In some embodiments, the outer and basket bottom walls are devoid of openings.

In an aspect, the filter system includes a pump fluidically communicating with the filter vessel. The pump can be in communication with the outlet to draw and discharge a liquid from filter vessel.

A method for filtering used cooking oil in a pressure fryer, which pressure fryer has a filter system having a filter vessel having a body, an inlet, an outlet, inner and outer baskets disposed in the body, a sidewall of the baskets having openings therein, a filter media disposed between the inner and outer baskets, and a pump fluidically communicating with the filter vessel, includes drawing a vacuum in the filter vessel, conveying the used cooking oil into the filter vessel, through the inner basket, the filter media and the outer basket to produce filtered used cooking oil.

Some methods include opening a vent valve in a vent line as the used oil is conveyed into the filter vessel, pumping filtered used cooking oil from the filter vessel, closing the vent valve as the filtered used cooking oil is pumped from the filter vessel, isolating the pump and drawing a vacuum in the filter vessel.

These and other features and advantages of the present device will be apparent from the following description, taken in conjunction with the accompanying sheets of drawings, and in conjunction with the appended claims.

### BRIEF DESCRIPTION OF THE DRAWINGS

The benefits and advantages of the present embodiments will become more readily apparent to those of ordinary skill in the relevant art after reviewing the following detailed description and accompanying drawings, wherein:

FIG. 1 is a perspective rendering of an embodiment of a pressure fryer having improved heating and filtering systems, the fryer being illustrated with a side panel removed and a front door open for ease of viewing;

FIG. 2 is a side view of the pressure fryer;

FIG. 3 is another side view of the fryer, reversed from FIG. 2, and shown in partial sectional view, illustrating the cooking vessel and filter;

FIG. 4 is another partial sectional view of the pressure fryer shown in a top perspective view;

FIG. 5 is a side view of the cooking well showing the vertical and undulating fins;

FIG. 6 is an enlarged view of a portion of the side of the cooking well showing the vertical and turbulator fins;

FIG. 7 is a side view of a turbulator fin;

FIG. 8 is a perspective view of an embodiment of an infrared burner;

FIG. 9 is a partial sectional view of an embodiment of a filter system used in the pressure fryer;

FIG. 10 is an exploded view of the filter system of FIG. 9;

FIG. 11 is a side view of the filter vessel showing the inlet and outlet lines; and

FIG. 12 is an enlarged partial view showing the filter vessel latch.

### DETAILED DESCRIPTION

While the present disclosure is susceptible of embodiment in various forms, there is shown in the drawings and will hereinafter be described one or more embodiments with the understanding that the present disclosure is to be considered illustrative only and is not intended to limit the disclosure to any specific embodiment described or illustrated.

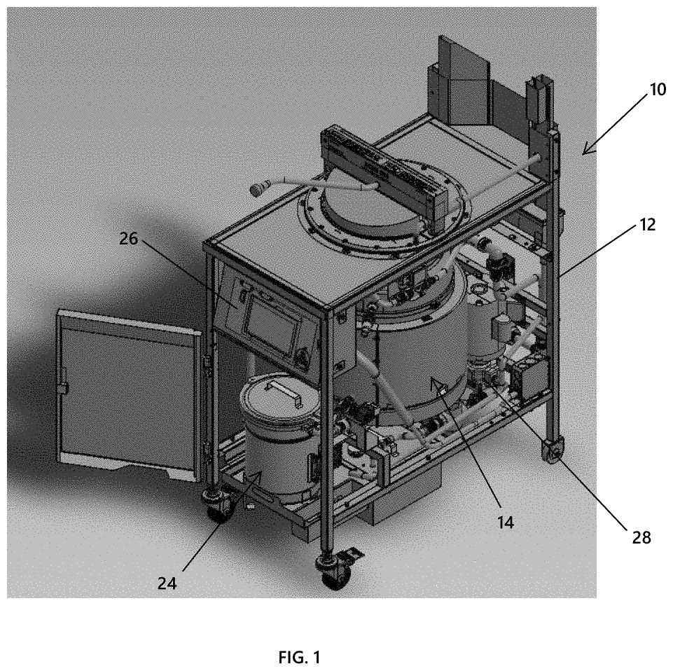

Referring now to the figures and in particular to FIGS. 1-3, there is shown an embodiment of a pressure fryer 10. The pressure fryer 10 (referred to herein as “fryer”) includes a frame 12, a cooking vessel system 14 including a cooking well 16, a cover 18, a burner system 20 and heat shield 22, a filter system 24 and a controller 26. The controller 26 controls the overall operation of the fryer 10. The fryer 10 further includes a pump 28, valves and piping, as will be discussed in more detail below, to transport oil through the system. In an embodiment, the pump 28 is located downstream of the filter system 24 to draw oil from the filter system 24. It will, however, be understood that the pump 28 can be located upstream of the filter system 24 so as to pump oil into the filter system 24.

The cooking well 16 is configured to store a quantity of heated oil, under pressure, to cook the food items in the well 16 while under pressure. In a typical arrangement, the oil may be heated to, and the food cooked at, a temperature of about 375 deg. F. at a pressure of about 12-14 psig. These cooking conditions have been shown to cook food faster, with less oil absorption, and thus less oil consumption, than deep frying.

The cooking well 16 has a conical bottom 30 and a substantially straight sidewall 32 extending upwardly from the conical bottom 30. An upper end of the sidewall 32 may include a flange 34 or like mounting member for mounting the cooking well 16 to the frame 12. The sidewall 32 may include a tapered collar 36 as it extends upwardly toward the flange 34. Inlets and outlets (for the transport of oil) can be formed in the sidewall 32 for conveying oil into and out of the cooking well 16. The cooking well 16 may also include one or more vents and the like, as will be recognized by those skilled in the art.

In order to increase the heat transfer from the burner 20 (which will be described in more detail below), the cooking well 16 includes a series of vertically extending fins 38 mounted to an outside surface of the well 16. In an embodiment, the fins 38 are mounted to the straight sidewall 32, above the conical bottom 30. The fins 38 may be mounted to a portion of sidewall 32, for example, a lower portion 40 of the sidewall 32. The fins 38 increase the surface area over which heat is transferred from the burner 20 to the well 16. In addition to the vertical fins 38, the present fryer 10 includes a series of turbulator fins 42 as best seen in FIGS. 5-7. The turbulator fins 42 are undulating elements that, in an embodiment are positioned between adjacent vertical fins 38.

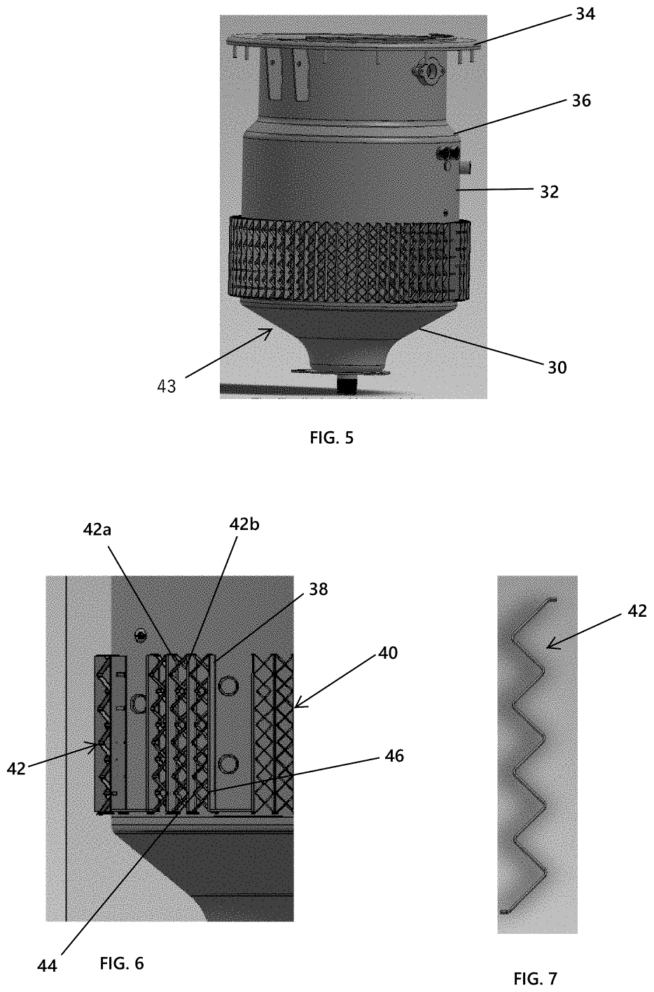

In an embodiment, the undulating shape of the turbulator gins 42 is a zig-zag shape (e.g., a group of “Z”s joint to one another defining peaks 44 and troughs 46) as seen in FIG. 7. Other undulating shapes, such as sinusoidal shapes and the like will be recognized by those skilled in the art. As seen in FIG. 6, in an embodiment, the turbulator fins 42 are positioned in opposing pairs between vertical fins 38. That is, the turbulator fins 42 are stacked on each other in opposite directions such that the peaks 44 of a fin, for example fin 42a oppose the troughs 46 of its fin pair, for example, fin 42b.

It has been observed that the turbulator fins 42, in conjunction with the vertical fins 38, increase the heat transfer from the burner 20 to the cooking well 16. The turbulator fins 42 increase the surface area in contact with the heated air (and/or burner 20 combustion products) and the surface area in contact with the cooking well 16 outer wall. In addition, the tortuous path (the zig-zag path) that the heated air takes along the turbulator fins 42 increases the contact time of the heated air with the fins 38, 42, generally, and creates a more turbulent flow of heated air along the heat transfer surfaces (the fins 38, 42 and cooking well 16 wall). As such, more energy is transferred from the heated air to the cooking well 16, thus increasing the efficiency of the burner system 20.

In an embodiment, a lower portion 43 of the cooking well 16, for example, the conical bottom 30, up to the fins 38, 42 may be coated with a material to enhance heat transfer from to the cooking well 16. For example, the coating may be a black coating such as a black oxidize coating, a black paint, such as a high temperature silicone-based flat black paint. A preferred material has a high absorptivity and a low emissivity.

In order to maintain the heated air around the cooking well 16 and the vertical and turbulator fins 38, 42, the heat shield 22 is positioned around that portion 40 of the cooking well 16 along which the fins 38, 42 extend. This also increases the heat transfer from the heated air to the cooking well 16. An exhaust 50 extends from the heat shield 22 to exhaust the heated air and combustion products.

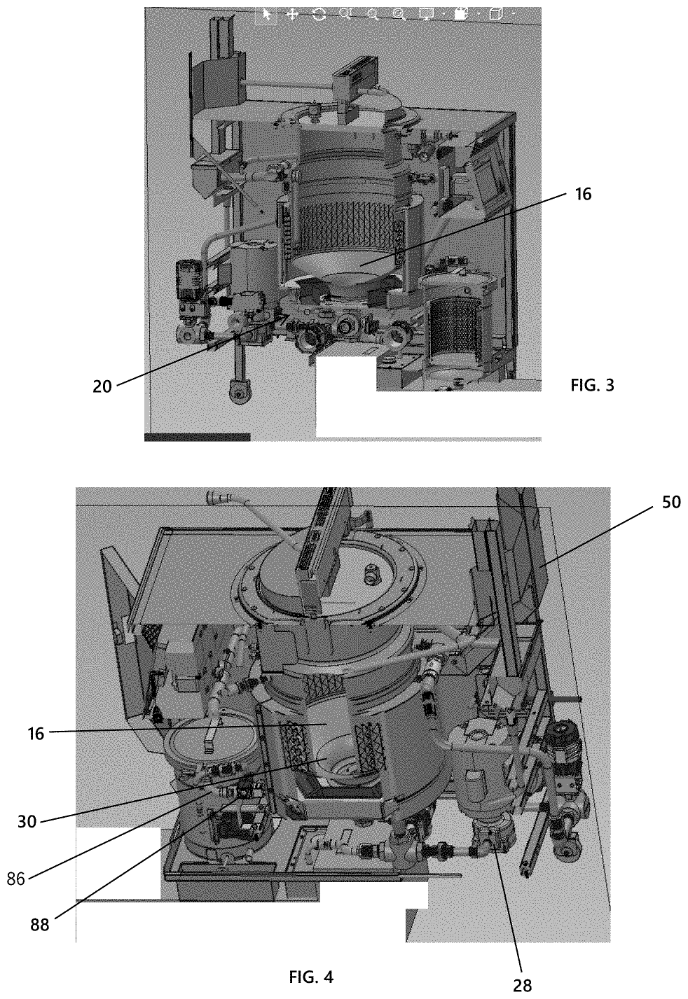

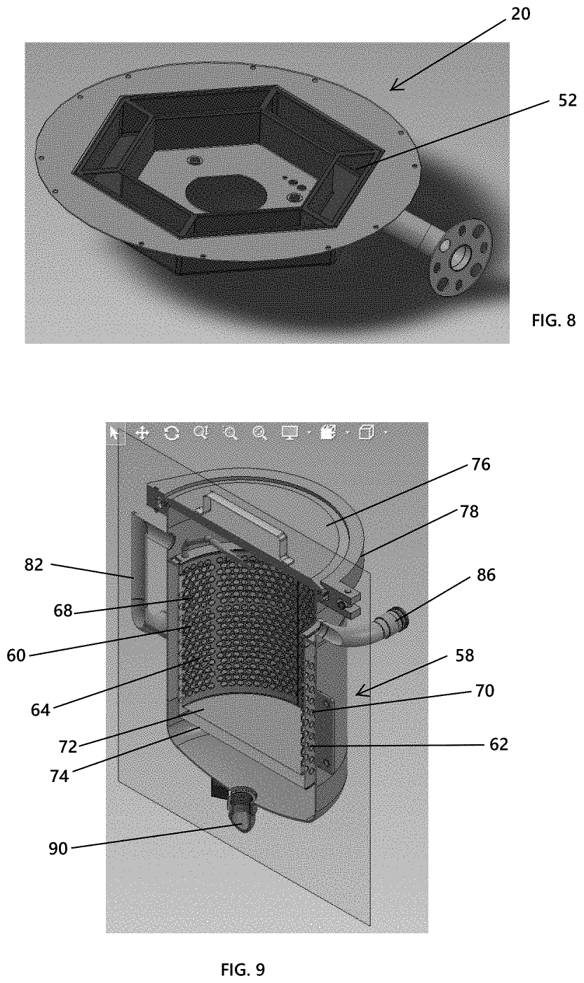

Referring to FIGS. 3, 4 and 8, an embodiment of the fryer 10 uses an infrared (IR) or radiant burner system 20. Unlike known fryers that use blue flame burners that heat using convective heat transfer, the IR burner system 20 heats the cooking well 16 through a combination of radiation (or radiant) and convective heat transfer. The use of radiant heat transfer provides a number of advantages. For example, IR heating elements 52 will heat objects by radiation (as well as surrounding air by convention), and as such will more efficiently heat the cooking well 16 and fins 38, 42. This is because the heated fins 38, 42 will then transfer heat by conduction to cooking well 16, which is a more efficient heat transfer mechanism than convective heat transfer. Moreover, IR heating elements 52 tend to reach higher temperatures than blue flame temperatures, again, increasing efficiency of the overall burner system 20. In fact, it has been found that in pressure fryers, while traditional blue flame burner systems operate at an efficiency of about 35-40 percent, the present IR burner system 20 operates at an efficiency of about 70 percent, thus providing a significant increase in efficiency and reduction in fuel costs.

The IR heating elements 52 can be metal, such as tungsten, iron, chromium, aluminum, alloys and combinations of these, and non-metals, such as ceramic, carob and the like and in combination with one or more metals. Such IR heating elements will be recognized by those skilled in the art.

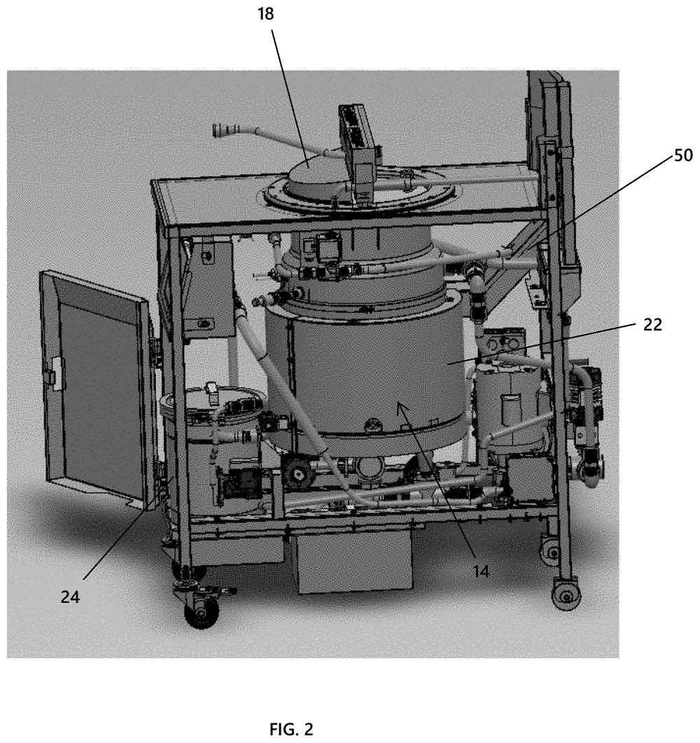

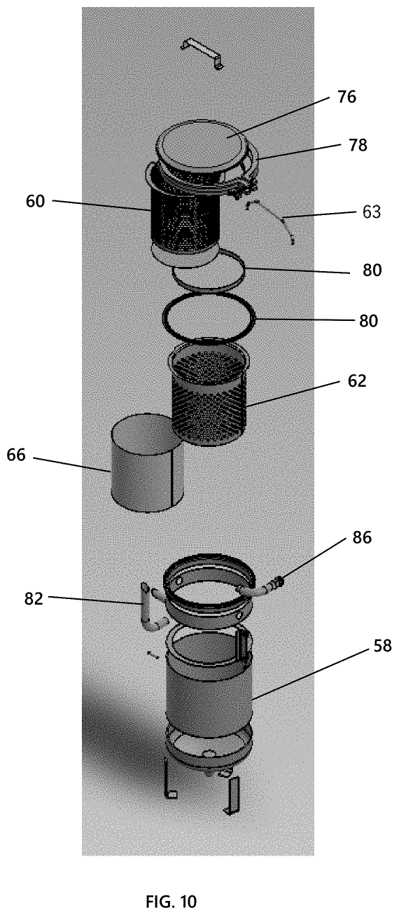

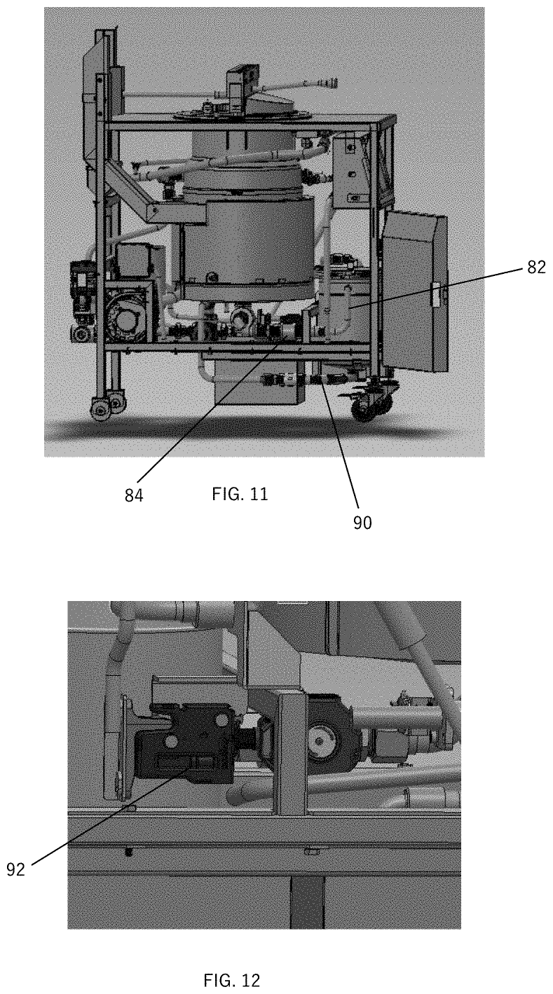

Referring now to FIGS. 2, 4 and 9-10, there is shown an embodiment of an improved filter system 24 for the fryer 10. Unlike known tray-type filter systems, the present filter system 24 uses a filter vessel 58 in which the oil is filtered to remove cooking debris. The system 24 includes the vessel 58 and inner and outer baskets, 60, 62, respectively. positioned in the vessel 58. The baskets 60, 62 have a series of openings or perforations 64 and a filter media 66 is positioned between the inner and outer baskets 60, 62. In an embodiment, the baskets' 60, 62 openings are formed in the baskets' walls 68, 70 (wall is singular since the baskets are round or cylindrical in shape), and solid, non-open bottoms 72, 74. In such a configuration, the filter media 66 can be, for example, a sheet material that encircles the inner basket wall 68. A present filter media 66 is a polymeric material. In an embodiment, the filter media 66 can be cleaned by scraping and is reusable. Other suitable media 66 materials, for example, Teflon-based media, will be recognized by those skilled in the art, and some media 66 may be cleaned, in for example, a dishwasher.

The filter system 24 includes a cover 76 and a clamp 78 to retain the cover 76 on the vessel 58, and one or more seals 80 between the vessel 58 and the cover 76. One or both of the baskets 60, 62 can have handles 63 for lifting and removing the baskets 60, 62 from the vessel 58.

In an embodiment, one or both of the inner and outer baskets 60, 62 may include openings in the bottom walls 72, 74. The baskets 60, 62 can be made of a metal, such as stainless steel; however, those skilled in the art will recognize and appreciate that other suitable materials, such as materials using metallized foam technology and non-metals may be used for one or both of the inner and outer baskets. In some embodiments, the basket material may allow for use of a single basket and/or use of a single basket or multiple baskets without a filter media.

The filter system 24 includes an inlet and line 82, and an inlet valve 84. The system 24 may also include a vent line 86 and a vent valve 88 positioned in the vent line 86. In an embodiment, the vent valve 88 is a solenoid operated valve; however, other suitable valve types will be recognized by those skilled in the art. An outlet line 90 draws oil from the bottom of the vessel 58. In an embodiment, the pump 28 draws oil from the filter vessel 58 outlet line 90, and returns the oil to the cooking well 16.

In one contemplated use, oil is transferred from the cooking well 16 to the filter vessel 58 by gravity. As the vessel 58 fills, the oil is drawn through the inner basket 60, through the filter media 66 and outer basket 62 and out through the vessel outlet 90. The oil can be drawn from the filter vessel 58 by the pump 28 and returned to the cooking well 16.

In one method of oil filtration, before oil is transferred to the filter, the filter vessel 58 has a slight negative pressure as will be described in more detail below. In, such a method, as oil is pumped out of the filter vessel 58, the vent valve 88 is opened to reduce any vacuum developed in the vessel 58, which facilitates pumping out the vessel 58. As the vessel 58 empties at the end of the filtering cycle, the vent valve 88 is closed to create a slight vacuum (slight negative pressure) in the vessel 58, just prior to isolating the pump 28 to end the filtering cycle. In this way, when the next filtering cycle begins, and the oil is returned to the filter vessel 28, the negative pressure in the vessel 58 increases the flow rate of oil from the cooking well 16 to the filter vessel 58.

The vent valve 88 also serves as a safety feature during cooking. In the event the isolation valve (is this the filter inlet valve) leaks, the normally closed vent valve 88 can be actuated during cooking to ensure that pressure will not build up in the filter vessel 58. In addition, there is a mechanical latch 92 that keeps the filter vessel 58 locked in place to allow assembly and removal of the filter baskets 60, 62 and media 66 without tools. The latch 92 also enhances safety if the vessel 58 is accidentally pressurized by a leaking (inlet) isolation valve by securely maintaining the filter vessel 58 in place on the frame 12.

Food cooking debris, such as crumbs, are removed by opening the cover 76 on the filter vessel 58 and simply lifting and separating the inner basket 60 from the outer basket 62. This can be carried out about every 25 cycles, or the following day when the filter 24 has cooled down. It is estimated that the time to carry out the filtering process (e.g., transferring oil from the cooking well 16 through the filter vessel 58, inner and outer baskets 60, 62 and filter media 66, and pumping the oil back to the cooking well 16) is about 1½ minutes (90 seconds) and crumb removal and return to operation will be less than 5 minutes. Advantageously, the present filtering system 24 does not require filtering compounds (no diatomaceous earth) and achieves a finer micron filtering level than known filer systems, at about 0.5 microns.

In the present disclosure, the words “a” or “an” are to be taken to include both the singular and the plural. Conversely, any reference to plural items shall, where appropriate, include the singular. It will also be appreciated by those skilled in the art that the relative directional terms such as upper, lower, rearward, forward and the like are for explanatory purposes only and are not intended to limit the scope of the disclosure.

All patents or patent applications referred to herein, are hereby incorporated herein by reference, whether or not specifically done so within the text of this disclosure.

From the foregoing it will be observed that numerous modification and variations can be effectuated without departing from the true spirit and scope of the novel concepts of the present film. It is to be understood that no limitation with respect to the specific embodiments illustrated is intended or should be inferred. The disclosure is intended to cover by the appended claims all such modifications as fall within the scope of the claims.

1. A cooking vessel for a pressure fryer, comprising:
a cooking well having a conical bottom and a substantially vertical sidewall extending upwardly from the conical bottom;
a series of vertical fins mounted to the sidewall, the vertical fins being spaced from one another;
a series of undulating fins mounted between the vertical fins; and
a cover for covering the cooking well.

2. The cooking vessel of claim 1, wherein the undulating fins define peaks and troughs.

3. The cooking vessel of claim 2, wherein the series of undulating fins includes first and second fin elements, the first and second fin elements mounted to each other in an opposing overlying configuration, such that the peaks of the first fin elements overlie the toughs of the second fin element.

4. The cooking vessel of claim 1, wherein the undulating fins extend along a portion of the sidewall.

5. The cooking vessel of claim 1, further including a heat shield positioned over the vertical fins and the undulating fins.

6. The cooking vessel of claim 1, further including a burner, wherein the burner is an infrared (IR) burner.

7. The cooking vessel of claim 1, wherein the cooking vessel includes a coating on a portion thereof.

8. The cooking vessel of claim 7, wherein the coating is on the conical portion.

9. The cooking vessel of claim 8, wherein the coating extends to about the series of vertical fins and the series of undulating fins.

10. A filter system for a pressure fryer, comprising:
a filter vessel having a body, an inlet, and an outlet;
an outer basket disposed in the body, a sidewall of the outer basket having openings therein, the outer basket having a bottom wall;
an inner basket disposed in the outer basket, a sidewall of the inner basket having openings therein, the inner basket having a bottom wall;
a filter media disposed between the inner basket and the outer basket.

11. The filter system of claim 10, wherein the outer basket bottom wall and inner basket bottom wall are devoid of openings.

12. The filter system of claim 10, further including a pump fluidically communicating with the filter vessel.

13. The filter system of claim 12, wherein the pump is fluidically communicating with the outlet to discharge a liquid from the filter vessel.

14. The filter system of claim 10 wherein the filter media is reusable.

15. The filter system of claim 10, further including a vent line

16. A method for filtering used cooking oil in a pressure fryer, the pressure fryer having a filter system having:
a filter vessel having a body, an inlet and, an outlet;
an outer basket disposed in the body, a sidewall of the outer basket having openings therein, the outer basket having a bottom wall,
an inner basket disposed in the outer basket, a sidewall of the inner basket having openings therein, the inner basket having a openings therein,
a filter media disposed between the inner basket and the outer basket, and
a pump fluidically communicating with the filter vessel, the method comprising:
drawing a vacuum in the filter vessel; and
conveying the used oil into the filter vessel, through the inner basket, the filter media and the outer basket to produce filtered used cooking oil.

17. The method of claim 16, wherein the filter vessel includes a vent line and a vent valve disposed in the vent line, and wherein the method includes opening the vent valve as the used cooking oil is conveyed into the filter vessel.

18. The method of claim 17, wherein the method includes closing the vent valve as the filtered used cooking oil is pumped out of the filter vessel.

19. The method of claim 18, wherein the method includes drawing a vacuum in the filter vessel as the filtered used cooking oil is pumped out of the vessel.

20. The method of claim 18, wherein the pump is located downstream of the filter vessel.
